(19) United States
(12) Patent Application Publication
(10) Pub. No.: US 2017/0101008 A1
(43) Pub. Date: Apr. 13, 2017

(54) WHEELIE DETERMINING DEVICE, VEHICLE, AND METHOD OF DETERMINING LIFT-OFF OF WHEEL

(71) Applicant: Kawasaki Jukogyo Kabushiki Kaisha, Kobe-shi (JP)

(72) Inventors: Tatsuya Hirokami, Osaka-shi (JP); Shohei Terai, Akashi-shi (JP); Seiji Azuma, Kako-gun (JP); Kengo Ueda, Akashi-shi (JP)

(21) Appl. No.: 15/288,411

(22) Filed: Oct. 7, 2016

(30) Foreign Application Priority Data
Oct. 7, 2015 (JP) 2015-199419

(51) Int. Cl. B60K 28/10

(52) U.S. Cl. CPC B60K 28/10; B60Y 2200/12; B60Y 2400/3032; B60Y 2400/301

(57) ABSTRACT

A wheelie determining device comprises a wheelie preceding state determiner section which makes a comparison between a vehicle body speed with respect to a ground surface and a circumferential speed of a front wheel to determine whether or not a vehicle is in a wheelie preceding state; and a wheelie amount determiner section which calculates as a wheelie amount which is a lift-off amount of the front wheel with respect to the ground surface, an angular change amount of the vehicle body in a rotational direction in which the front wheel is away from the ground surface, from a time point when the wheelie preceding state determiner section has determined that the vehicle has been in the wheelie preceding state.

### CROSS-REFERENCE TO RELATED APPLICATION

This application claims priority to and the benefit of Japanese Patent Application No. 2015-199419 filed on Oct. 7, 2015, the entire disclosure of which is incorporated herein by reference.

### BACKGROUND OF THE INVENTION

Field of the Invention

The present invention relates to a wheelie determining device, a vehicle including the wheelie determining device, and a method of determining a lift-off amount of a wheel of the vehicle.

Description of the Related Art

An engine output control device disclosed in JP2010-229912A calculates a vehicle body pitch angle based on a detection value of a gyro sensor. The engine output control device determines that a wheelie is occurring in a vehicle, when the vehicle body pitch angle is equal to or larger than a predetermined value.

Due to factors which are other than a lift-off of a front wheel from the ground surface, such as a change in a slope of a ground surface, the vehicle body is sometimes tilted in a pitch direction with respect to a horizontal direction. The gyro sensor detects the tilt of the vehicle body due to the factors which are other than the lift-off of the front wheel, as a tilt angle of the vehicle body with respect to the horizontal direction. For this reason, the engine output control device may erroneously determine that a wheelie is occurring in the vehicle, even in a case where the front wheel is not away from the ground surface.

### SUMMARY OF THE INVENTION

An object of the present invention is to accurately determine a lift-off of a wheel from a ground surface.

According to an aspect of the present invention, a wheelie determining device comprises a wheelie preceding state determiner section which makes a comparison between a vehicle body speed with respect to a ground surface and a circumferential speed of a front wheel to determine whether or not a vehicle is in a wheelie preceding state; and a wheelie amount determiner section which calculates as a wheelie amount which is a lift-off amount of the front wheel with respect to the ground surface, an angular change amount of the vehicle body in a rotational direction in which the front wheel is away from the ground surface, from a time point when the wheelie preceding state determiner section has determined that the vehicle has been in the wheelie preceding state.

In accordance with this configuration, the angular change amount of the vehicle body from the time point when the wheelie preceding state determiner section has determined that the vehicle has been in the wheelie preceding state is calculated as the lift-off amount (wheelie amount) of the front wheel from the ground surface. In this configuration, the influences of the tilt of the vehicle body which occurred before the wheelie preceding state determiner section determines that the vehicle is in the wheelie preceding state can be excluded, and thereby the lift-off amount indicating to what extent the front wheel is away from the ground surface can be accurately estimated.

The wheelie preceding state determiner section may estimate the vehicle body speed with respect to the ground surface based on a circumferential speed of a rear wheel.

In accordance with this configuration, the vehicle body speed can be easily estimated when the wheelie preceding state determiner section determines whether or not the vehicle is in the wheelie preceding state. The circumferential speed of the rear wheel can also be easily obtained from the rotational speed of a rotary member which is rotatable in association with the rotation of the rear wheel.

The wheelie preceding state determiner section may determine whether or not the vehicle is in the wheelie preceding state based on a vehicle body acceleration rate with respect to the ground surface.

In accordance with this configuration, the wheelie preceding state determiner section determines whether or not the vehicle is in the wheelie preceding state based on the vehicle body acceleration rate in addition to the difference between the circumferential speed of the front wheel and the vehicle body speed. Therefore, in a situation in which the difference between the circumferential speed of the front wheel and the vehicle body speed increases even though a probability with which the wheelie will occur anytime soon is low, the wheelie preceding state determiner section can accurately determine that this situation is not the wheelie preceding state, based on the vehicle body acceleration rate.

The rear wheel may be driven by driving power generated by the drive source, and the wheelie preceding state determiner section may determine whether or not the vehicle is in the wheelie preceding state based on an output of the drive source.

In accordance with this configuration, the wheelie preceding state determiner section determines whether or not the vehicle is in the wheelie preceding state based on the output of the drive source in addition to the difference between the circumferential speed of the front wheel and the vehicle body speed. Therefore, in a situation in which the difference between the circumferential speed of the front wheel and the vehicle body speed increases even though a probability with which the wheelie will occur anytime soon is low, the wheelie preceding state determiner section can accurately determine that this situation is not the wheelie preceding state, based on the output of the drive source.

The wheelie preceding state determiner section may compare a difference between the vehicle body speed with respect to the ground surface and the circumferential speed of the front wheel to a threshold set for each vehicle body speed, to determine whether or not the vehicle is in the wheelie preceding state.

In accordance with this configuration, the wheelie preceding state determiner section can accurately determine whether or not the vehicle is in the wheelie preceding state based on the vehicle body speed.

The wheelie preceding state determiner section may determine whether or not the vehicle is in the wheelie preceding state based on a rotational acceleration rate of the front wheel.

In accordance with this configuration, the wheelie preceding state determiner section determines whether or not the vehicle is in the wheelie preceding state based on the rotational acceleration rate of the front wheel in addition to the difference between the circumferential speed of the front wheel and the vehicle body speed. Therefore, in a situation in which the difference between the circumferential speed of the front wheel and the vehicle body speed increases even though a probability with which the wheelie will occur anytime soon is low, the wheelie preceding state determiner section can accurately determine that this situation is not the wheelie preceding state, based on the rotational acceleration rate of the front wheel.

The wheelie amount determiner section may determine whether or not the vehicle has become a wheelie state, based on the wheelie amount, and the wheelie amount determiner section may determine whether or not the wheelie state has terminated, based on a rotational speed of the front wheel and the wheelie amount.

In accordance with this configuration, even if the difference between the circumferential speed of the front wheel and the vehicle body speed is eliminated in a situation in which the front wheel is away from the ground surface, it becomes possible to prevent a situation in which the wheelie amount determiner section erroneously determines that the wheelie state has terminated.

According to another aspect of the present invention, a vehicle comprises the above-described wheelie determining device; a drive source which generates driving power for the vehicle to travel; and an output suppressing section which performs a wheelie suppressing control for suppressing an output generated by the drive source, when the wheelie amount becomes a predetermined value or more.

In accordance with this configuration, the driving power can be suppressed according to the extent of the wheelie determined accurately. Therefore, it becomes possible to avoid a situation in which the driving power is undesirably suppressed even though the wheelie is not occurring, or a situation in which the driving power is not suppressed even though the wheelie is occurring and the wheelie continues.

The output suppressing section may perform a slip suppressing control for suppressing the driving power generated by the drive source to suppress a slip of the front wheel with respect to the ground surface, based on the vehicle body speed with respect to the ground surface and the circumferential speed of the front wheel, and the output suppressing section may terminate the slip suppressing control and perform the wheelie suppressing control, when a condition used to perform the wheelie suppressing control is met, while the output suppressing section is performing the slip suppressing control.

In accordance with this configuration, the wheelie suppressing control can be initiated after the lift-off of the vehicle body has been detected, and the slip suppressing control and the wheelie suppressing control can be separately performed. Since the slip suppressing control and the wheelie suppressing control are made different from each other, the suitable control for each of the slip and the wheelie can be performed, and the slip suppressing control and the wheelie suppressing control can be suitably performed.

According to a further aspect of the present invention, a method of determining a lift-off amount of a wheel, which determines a lift-off amount of one of a front wheel and a rear wheel which are included in a vehicle, with respect to a ground surface, comprises making a comparison between a vehicle body speed with respect to the ground surface and a circumferential speed of one of the front and rear wheels to determine whether or not one of the front and rear wheels is in a lift-off preceding state; and calculating as a wheel lift-off amount which is the lift-off amount of one of the front and rear wheels with respect to the ground surface, an angular change amount of the vehicle body in a rotational direction in which one of the front and rear wheels is away from the ground surface, from a time point when it has been determined that the vehicle has been in the lift-off preceding state.

In accordance with this method, the lift-off amount of one of the front and rear wheels with respect to the ground surface can be accurately determined.

The above and further objects, features and advantages of the present invention will more fully be apparent from the following detailed description of preferred embodiment with reference to accompanying drawings.

### BRIEF DESCRIPTION OF THE DRAWINGS

FIG. 1 is a left side view of a motorcycle which is an exemplary vehicle.

FIG. 2 is a flow chart showing a method of determining a lift-off amount of a wheel.

FIG. 3 is a block diagram showing a control system of the vehicle including a wheelie determining device.

FIG. 4 is a block diagram showing the configuration and processing of a wheelie preceding state determiner section.

FIG. 5 is a block diagram showing the configuration and processing of a termination determiner section.

### DETAILED DESCRIPTION OF THE EMBODIMENTS

Hereinafter, the embodiments of the present invention will be described with reference to the drawings. The directions stated below are from the perspective of a rider riding in a vehicle. A forward and rearward direction corresponds with a vehicle length direction, while a rightward and leftward direction corresponds with a vehicle width direction.

### Embodiment 1

(Vehicle)

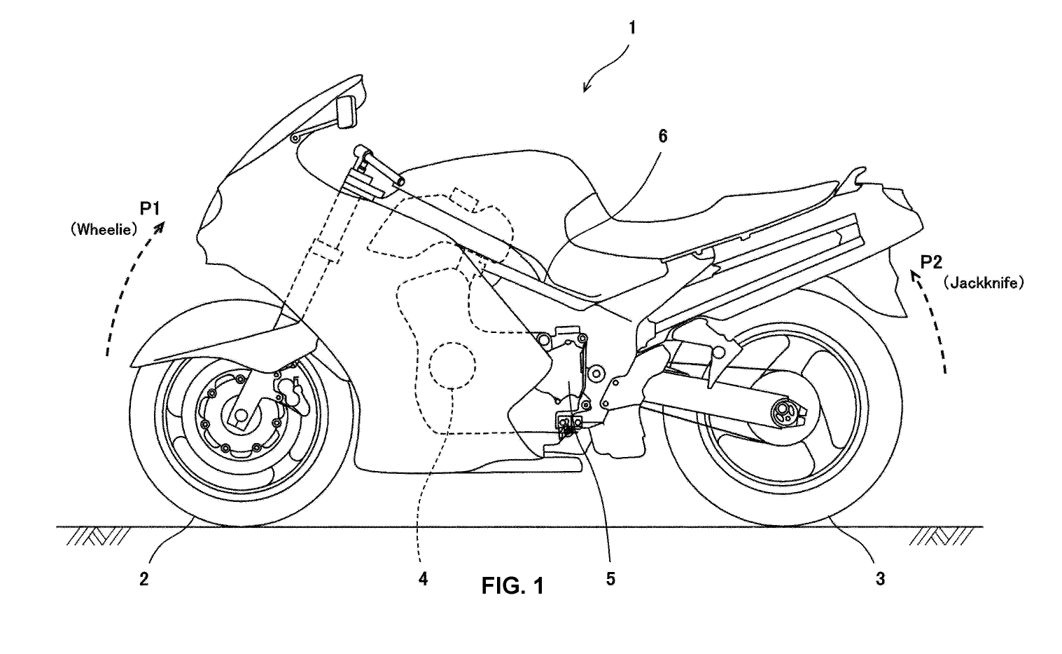

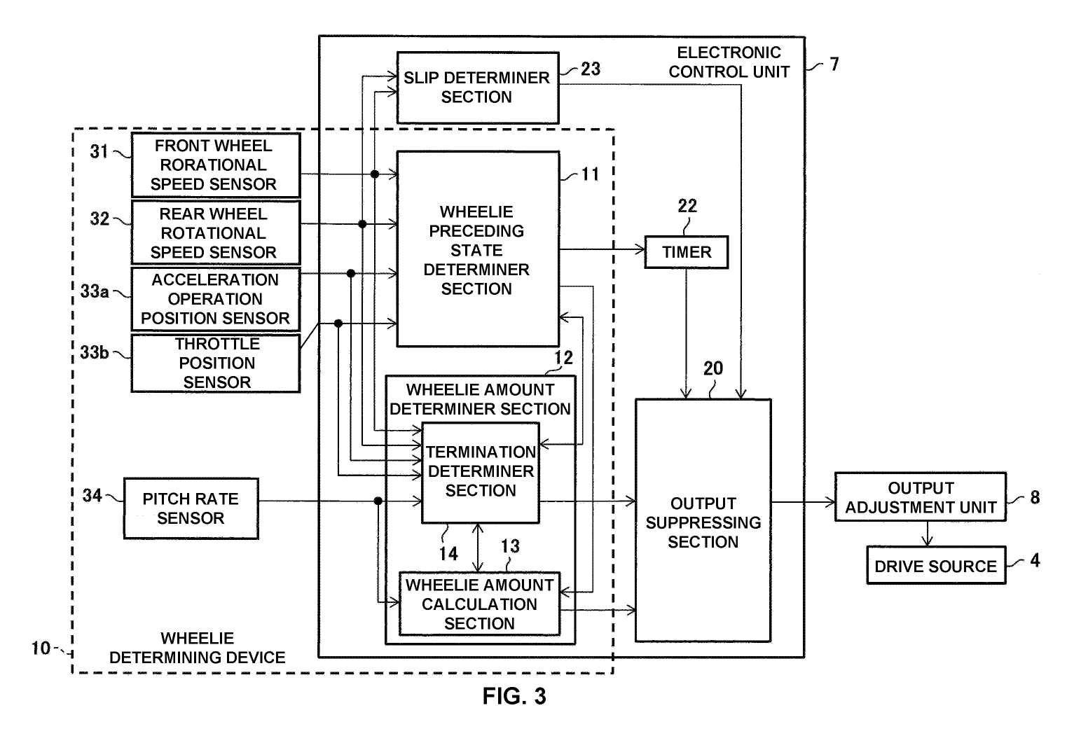

As shown in FIG. 1, a vehicle 1 includes a front wheel 2 and a rear wheel 3. In the vehicle 1, the rear wheel 3 is driven by driving power generated by a drive source 4. The drive source 4 is an engine, an electric motor, or a combination of the engine and the electric motor. The driving power generated by the drive source 4 is transmitted to the rear wheel 3 via a driving power transmission mechanism 5. The vehicle 1 includes a wheelie determining device 10 (see FIG. 3), and uses a wheel lift-off amount determination method while the vehicle 1 is traveling.

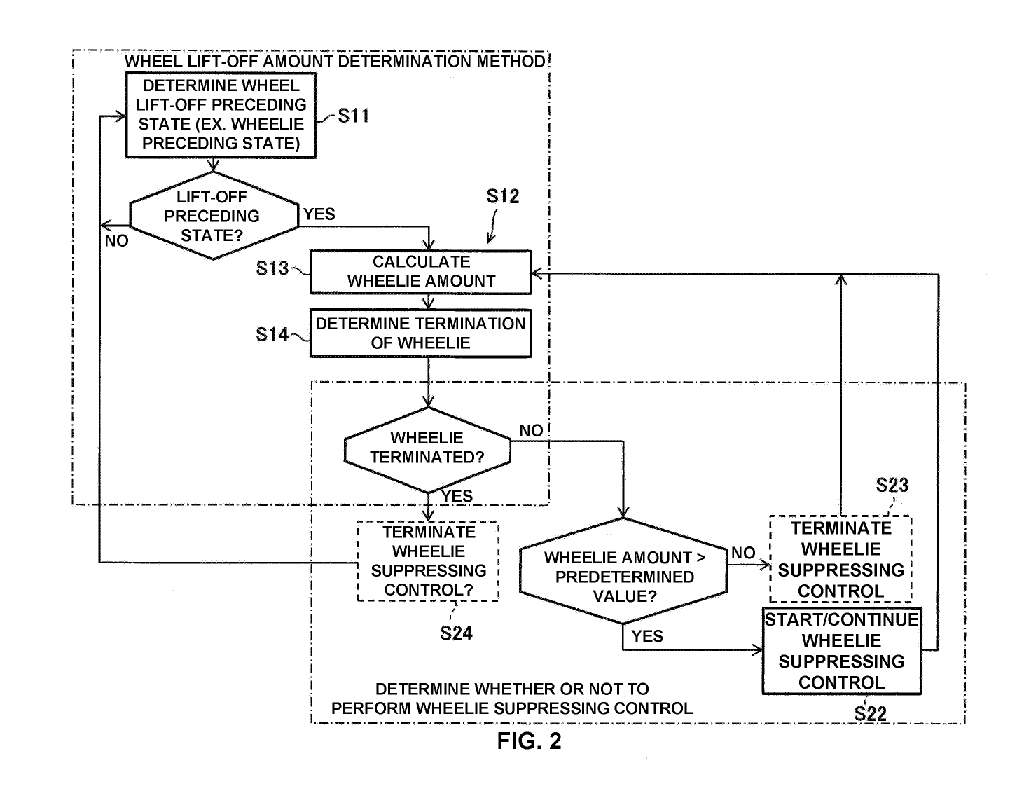

The motorcycle which is exemplarily shown as the vehicle 1 includes one front wheel 2 and one rear wheel 3. A wheel base between the front wheel 2 and the rear wheel 3 is small. An output generated by the drive source 4 with respect to a vehicle weight is great. For this reason, there is a tendency that a wheelie in which the front wheel 2 lifts off the ground surface or a jackknife in which the rear wheel 3 lifts off the ground surface occurs in the motorcycle. Therefore, the motorcycle is a suitable example of the vehicle 1 including the wheelie determining device 10 (see FIG. 2), or the vehicle 1 which uses a wheel lift-off amount determination method.

The “wheel lift-off amount” is defined as a lift-off amount indicating to what extent one of the front wheel 2 and the rear wheel 3 lifts off the ground surface. In a case where the wheel is the front wheel 2, the wheel lift-off amount will be referred to as a “wheelie amount.” In a case where the wheel is the rear wheel 3, the wheel lift-off amount will be referred to as a “jackknife amount.”

While the front wheel 2 is lifting off the ground surface (the wheelie amount is increasing), a vehicle body 6 is angularly displaced in a clockwise direction P1 in a left side view, around an imaginary rotational axis extending in the vehicle width direction and passing through a point on which the rear wheel 3 is grounded. While the rear wheel 3 is lifting off the ground surface (the jackknife amount is increasing), the vehicle body 6 is angularly displaced in a counterclockwise direction P2 in the left side view, around an imaginary rotational axis extending in the vehicle width direction and passing through a point on which the front wheel 2 is grounded. Hereinafter, the rotation of the vehicle body 6 around the imaginary axis extending in the vehicle width direction will be referred to as a “pitch”, and the rotation angle of the vehicle body 6 around this rotational axis will be referred to as a “pitch angle.”

(Wheel Lift-off Amount Determination Method)

The wheel lift-off amount determination method of FIG. 2 is performed while the vehicle 1 is traveling. The wheel lift-off amount determination method includes a lift-off preceding state determination step S11 and a lift-off amount determination step S12.

In the lift-off preceding state determination step S11, a comparison is made between a ground speed and a circumferential speed of one of the wheels 2, 3 to determine whether or not one of the wheels 2, 3 is in a lift-off preceding state. When it is determined that one of the wheels 2, 3 is not in the lift-off preceding state, the lift-off preceding state determination step is repeated. The “wheel lift-off preceding state” includes a “wheelie preceding state” of the front wheel 2 and a “jackknife preceding state” of the rear wheel 3.

The lift-off amount determination step S12 includes a lift-off amount calculation step S13 and a lift-off termination determination step S14. In the lift-off amount calculation step S13, a change amount of the angle of the vehicle body 6 in a rotational direction (in the clockwise direction P1 in the left side view, in the case of the front wheel 2) in which one of the wheels 2, 3 is away from the ground surface, from a time point when it has been determined that one of the wheels 2, 3 has been in the lift-off preceding state, is calculated as the wheel lift-off amount which is the lift-off amount of one of the wheels 2, 3, with respect to the ground surface. The “ground speed” refers to a movement speed [m/s] of the vehicle body 6 with respect to the ground surface. The “circumferential speed” refers to a speed of a rotating object at an arbitrary radial position and is indicated by 2πRn[m/s] (R is a radius [m] at the radial position, and n is the rotational speed [1/s] of the object). When the circumferential speed of the wheel 2, 3 is found, the ground surface may be set as the radial position.

In the lift-off termination determination step S14, it is determined whether or not the lift-off of one of the wheels 2, 3 has terminated, based on the rotational acceleration rate of one of the wheels 2, 3 and the calculated lift-off amount of one of the wheels 2, 3. When it is determined that the lift-off of one of the wheels 2, 3 continues, the lift-off amount determination step S12 is repeated. When it is determined that the lift-off of one of the wheels 2, 3 has terminated, the process returns to the lift-off preceding state determination step S11. Correspondingly, calculation of the lift-off amount ends.

The remaining steps S21 to S24 of FIG. 2 will be described later. Initially, for the explanation of the lift-off preceding state determination step S11 and the lift-off amount determination step S12, the configuration and operation of the wheelie determining device 10 (see FIG. 3) which performs the wheel lift-off amount determination method for, in particular, the front wheel 2, of one of the wheels 2, 3, will be hereinafter described.

(Wheelie Determining Device)

As shown in FIG. 3, the control system of the vehicle 1 includes the wheelie determining device 10. To perform the wheel lift-off amount determination method for the front wheel 2, the wheelie determining device 10 includes a wheelie preceding state determiner section 11 and a wheelie amount determiner section 12. The wheelie preceding state determiner section 11 performs the lift-off preceding state determination step S11 for the front wheel 2. The wheelie amount determiner section 12 performs the wheel lift-off amount determination step S12 for the front wheel 2. The wheelie amount determiner section 12 includes a wheelie amount calculation section 13 and a wheelie termination determiner section 14. The wheelie amount calculation section 13 performs the wheel lift-off amount calculation step S13 for the front wheel 2. The wheelie termination determiner section 14 performs the lift-off termination determination step S14 for the front wheel 2. These sections 11 to 14 are realized by an electronic control unit (ECU) 7 mounted in the vehicle 1. The wheelie determining device 10 includes the ECU 7. The ECU 7 receives as inputs, information used to determine whether or not the vehicle 1 is in a wheel lift-off preceding state (wheelie preceding state), and information indicating the rotational angle of the vehicle body 6. A processor section of the ECU 7 executes programs stored in a memory section of the ECU 7. The ECU 7 outputs a signal indicating occurrence/non-occurrence of the wheelie state and a signal indicating the wheelie amount.

<Wheelie Preceding State Determiner Section>

The wheelie preceding state determiner section 11 determines whether or not the vehicle 1 is in the wheelie preceding state, or whether or not the vehicle 1 has shifted from a non-wheelie-preceding state to the wheelie preceding state. The term “wheelie preceding state” is defined as a state in which the wheelie has started, a state in which the wheelie is about to start, or a state in which it is highly probable that the wheelie will occur anytime soon.

Now, a traveling state at the start of the wheelie will be described. The output of the drive source 4 is great, and great driving power is transmitted from the drive source 4 to the rear wheel 3 which is a drive wheel. The ground speed and the ground acceleration rate are high. When the front wheel 2 lifts off the ground surface, the front wheel 2 rotates by inertia in a state in which the front wheel 2 is applied with an air resistance or a friction with an axle, and the rotational speed and circumferential speed of the front wheel 2 are gradually reduced. Therefore, the “wheelie preceding state” may include a “state in which the circumferential speed of the front wheel 2 is lower than the ground speed, and there is a difference between the ground speed and the circumferential speed of the front wheel 2.”

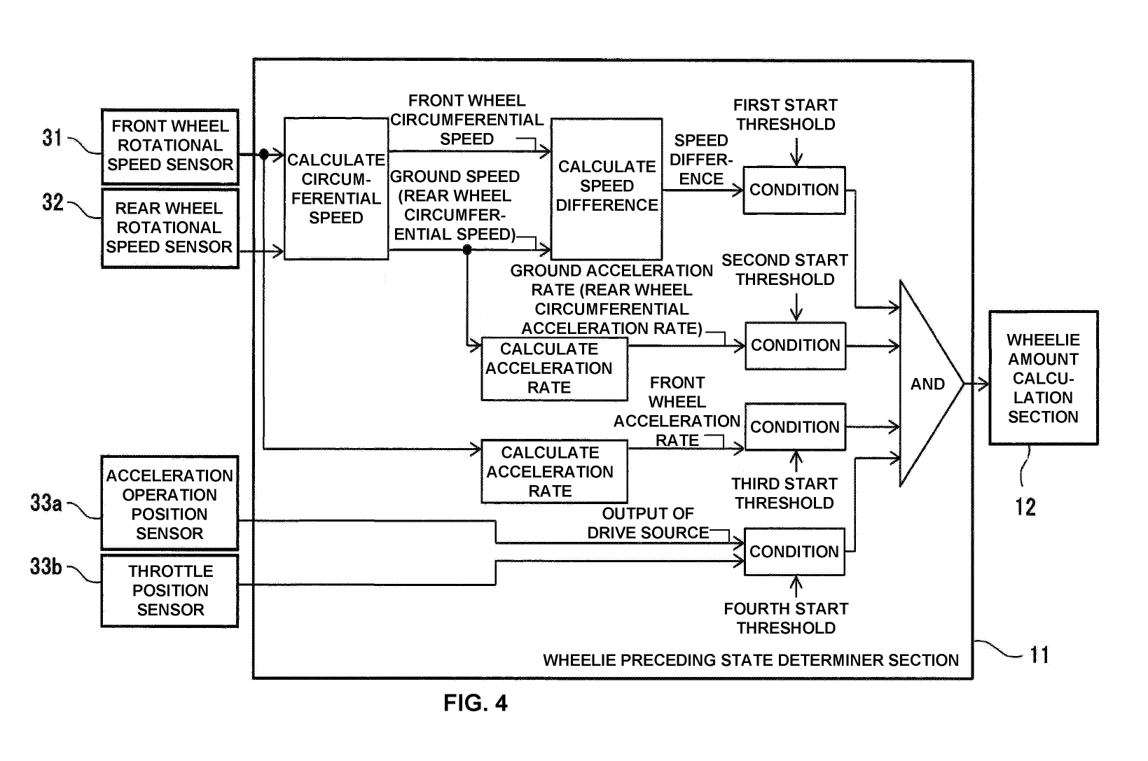

In view of the above, as shown in FIG. 4, the wheelie preceding state determiner section 11 makes a comparison between the ground speed and the circumferential speed of the front wheel 2, to determine whether or not the vehicle 1 is in the wheelie preceding state. Specifically, the wheelie preceding state determiner section 11 uses a difference between the ground speed and the circumferential speed of the front wheel 2 (difference is a value obtained by subtracting the circumferential speed from the ground speed), as one of parameters used to determine whether or not the vehicle 1 is in the wheelie preceding state.

The wheelie preceding state determiner section 11 determines whether or not a first condition is met, in which the difference between the ground speed and the circumferential speed of the front wheel 2 is equal to or greater than a first start threshold (positive value). During normal traveling, the ground speed is substantially equal to the circumferential speed of the front wheel 2. By setting the first start threshold to a value which is outside a variation range of the difference between the ground speed and the circumferential speed of the front wheel 2, which occurs during the normal traveling, the first condition is not met during the normal traveling. Also, by determining that the vehicle 1 is in the wheelie preceding state when the first condition is met, the determination accuracy of the wheelie preceding state is increased.

The first start threshold may be set according to the ground speed. For example, the first start threshold may be set to be smaller as the ground speed is higher. This makes it possible to effectively cancel a noise, and increase the determination accuracy of the wheelie preceding state.

However, the condition in which the vehicle 1 is in the “wheelie preceding state” may be a sufficient condition but may not be a necessary condition, for the “state in which the circumferential speed of the front wheel 2 is lower than the ground speed, and there is a difference between the ground speed and the circumferential speed of the front wheel 2.” In some cases, even in a particular traveling state (e.g., during traveling on a low-pt road) which is other than occurrence of the wheelie, the wheel 2, 3 exhibits the above-described behavior as in the case of occurrence of the wheelie, and thereby the first condition is met.

In view of the above-described circumstances, the wheelie preceding state determiner section 11 determines whether or not several conditions as well as the first condition are met. The wheelie preceding state determiner section 11 determines that the vehicle 1 is in the wheelie preceding state when other conditions as well as the first condition are met. In the present embodiment, the wheelie preceding state determiner section 11 determines whether or not the vehicle 1 is in the wheelie preceding state, based on parameters such as (1) the difference between the ground speed and the circumferential speed of the front wheel 2, (2) the ground acceleration rate, (3) the rotational acceleration rate of the front wheel 2, and (4) the output of the drive source 4. The “ground acceleration rate” refers to a movement acceleration rate [m/s²] of the vehicle body 6 with respect to the ground surface.

In association with the above-described parameters (1) and (3), the wheelie determining device 10 includes a front wheel rotational speed sensor 31 which is attached on the front wheel 2 and detects the rotational speed of the front wheel 2. The wheelie preceding state determiner section 11 receives as an input a detection value from the front wheel rotational speed sensor 31, and derives the circumferential speed of the front wheel 2 and the rotational acceleration rate of the front wheel 2 based on the received detection value.

In association with the above-described parameters (1) and (2), the wheelie preceding state determiner section 11 may measure the ground speed and the ground acceleration rate, based on a detection value from a sensor which uses a radio wave such as a GPS sensor, instead of an acceleration sensor. The wheelie preceding state determiner section 11 may estimate the ground speed and the ground acceleration rate based on the circumferential speed of the rear wheel 3. In other words, in the parameter (1) and the parameter (2), the ground speed and the ground acceleration rate may be replaced by the circumferential speed and circumferential acceleration rate of the rear wheel 3, respectively.

In that case, to obtain the circumferential speed of the rear wheel 3, the wheelie determining device 10 includes a rear wheel rotational speed sensor 32 which detects the rotational speed of the rear wheel 3. The wheelie preceding state determiner section 11 receives as an input a detection value from the rear wheel rotational speed sensor 32, and derives the circumferential speed of the rear wheel 3 based on the input detection value. The circumferential acceleration rate of the rear wheel 3 can be easily derived based on a present value and a past value (e.g., latest value of previous values) of the circumferential speed.

The rear wheel rotational speed sensor 32 may be a sensor attached to the rear wheel 3 to detect the rotational speed of the rear wheel 3. The rear wheel rotational speed sensor 32 is not limited to such a sensor, and may be a sensor which detects the rotational speed of a rotary member (e.g., the output shaft of the drive source 4 or a rotary shaft included in the driving power transmission mechanism 5) which is rotatable in association with the rotation of the rear wheel 3. The wheelie preceding state determiner section 11 can easily convert the rotational speed of the rotary member into the rotational speed of the rear wheel 3 by use of a speed ratio of the rotary member with respect to the rear wheel 3. When the ground speed or the ground acceleration rate is estimated by use of the rear wheel rotational speed sensor 32, the numeric value of the ground speed or the ground acceleration rate can be easily obtained, compared to a case where the ground speed or the ground acceleration rate is directly measured based on the detection value of the sensor which uses a radio wave.

The parameter (4) need not be the output itself of the drive source 4, and may be other parameters which significantly affect the output of the drive source 4. For example, when the rider inputs an acceleration request command by use of an acceleration operation unit (e.g., twists an accelerator grip or presses down an accelerator pedal), an output adjustment unit 8 which adjusts the output of the drive source 4 is electronically or mechanically operated in response to the acceleration request command. Thereby, the output of the drive unit 4 is increased. The output adjustment unit 8 is different depending on the type of the drive source 4. In a case where the drive source 4 includes a spark ignition type engine, the output adjustment unit 8 includes a throttle valve, an injector, and an ignition plug. In a case where the drive source 4 includes an AC motor, the output adjustment unit 8 includes an inverter electrically connected to the AC motor.

In association with the parameter (4), the wheelie determining device 10 may include an acceleration operation position sensor 33a which detects an operation position of the acceleration operation unit. In a case where the drive source 4 includes an engine, the wheelie determining device 10 may include a throttle valve position sensor 33b which detects a throttle valve opening degree (namely, the rotational position of a valve element). Further, the wheelie determining device 10 may include an air-intake pressure sensor (not shown) which detects an air-intake pressure. The wheelie preceding state determiner section 11 receives as input(s) detection value(s) from the sensor 33a and/or the sensor 33b at specified sampling rates, and estimates the output of the drive source 4, based on the input detection value(s).

The wheelie preceding state determiner section 11 determines whether or not a second condition is met, in which the ground acceleration rate is equal to or higher than a second start threshold. In addition, the wheelie preceding state determiner section 11 determines whether or not a third condition is met, in which the rotational acceleration rate of the front wheel 2 is lower than a third start threshold. Further, the wheelie preceding state determiner section 11 determines whether or not the output of the drive source 4 is equal to or greater than a fourth start threshold. When the wheelie preceding state determiner section 11 determines that all of the first to fourth conditions are met, it determines that the vehicle 1 is in the wheelie preceding state.

In the above-described manner, when the wheelie preceding state determiner section 11 determines that all of the first to fourth conditions are met, it determines that the vehicle 1 is in the wheelie preceding state. This makes it possible to accurately determine whether or not the vehicle 1 is in the wheelie preceding state, or whether or not the vehicle 1 has shifted from the non-wheelie-preceding state to the wheelie preceding state. Therefore, in a situation in which the difference between the ground speed and the circumferential speed of the front wheel 2 increases even though a probability with which the wheelie will occur anytime soon is low, the wheelie preceding state determiner section 11 can accurately determine that this situation is not the wheelie preceding state, based on the ground acceleration rate, the rotational acceleration rate of the front wheel 2 or the output of the drive source 4.

For example, in a case where the ground speed is estimated from the circumferential speed of the rear wheel 3, the first condition is sometimes met, even in a situation in which the rotational speed of the rear wheel 3 is excessively high with respect to the rotational speed of the front wheel 2 due to a low friction resistance of the ground surface. However, under this situation, it is difficult to accelerate the vehicle body 6. By determining whether or not the second condition is met, it becomes possible to precisely distinguish between a case where the difference between the circumferential speed of the rear wheel 3 and the circumferential speed of the front wheel 2 increases due to the low friction resistance of the ground surface, and a case where the difference between the circumferential speed of the rear wheel 3 and the circumferential speed of the front wheel 2 increases while the vehicle body 6 is accelerated. Thus, the wheelie preceding state determiner section 11 can accurately determine whether or not the vehicle 1 is in the wheelie preceding state. To realize this, the ground acceleration rate is preferably estimated or measured based on a detection value other than the detection value of the circumferential speed of the rear wheel 3.

Alternatively, a slip ratio may be used as the parameter (1). The slip ratio S[−] is derived based on the following formula: S=(Vf−Vr)/Vf (Vf is the circumferential speed [m/s]of the front wheel 2, Vr is the circumferential speed [m/s] of the rear wheel 3). As described above, the ground speed may be replaced by the circumferential speed of the rear wheel 3. Therefore, a factor (Vf−Vr) in the above formula corresponds to the “difference between the ground speed and the circumferential speed of the front wheel 2.” Vf may be replaced by the rotational speed [1/s] of the front wheel 2, and Vr may be replaced by the rotational speed [1/s] of the rear wheel 3. The slip ratio is derived in succession at each of specified sampling rates, by use of the detection values input from the front wheel rotational speed sensor 31 and the rear wheel rotational speed sensor 32 at the specified sampling rates. Further, in addition to the slip ratio, a slip rate change rate may be used as the parameter (1). The slip ratio change rate ΔS[1/s] is derived according to the following formula: ΔS(n)=(S(n)−S(n−1))/t (t is the above-described sampling rate, S(n) is a present value of the slip ratio S, and S(n−1) is a past value of the slip ratio S, which was obtained at a time point which was one sampling rate before the time point when the present value S(n) is obtained). A calculation formula of the slip ratio change rate AS contains the “difference between the ground speed and the circumferential speed of the front wheel 2”, as a factor.

The slip ratio and the slip ratio change rate are measured by use of the front wheel rotational speed sensor and the rear wheel rotational speed sensor which are generally included in the vehicle 1. For the measurement of the slip ratio and the slip ratio change rate, a special or additional sensor is not necessary, which can prevent the configuration of the system from becoming complicated.

In a case where the slip ratio and the slip ratio change rate are used as the parameter (1), the slip ratio preceding state determiner section 11 determines whether or not the slip ratio is equal or greater than a predetermined value, and whether or not the slip ratio change rate is equal to or greater than a predetermined value. When the slip ratio preceding state determiner section 11 determines that both of the two conditions are met, it determines that the above-described first condition is met.

<Wheelie Amount Calculation Section>

Turning back to FIG. 3, when the wheelie preceding state determiner section 11 determines that the vehicle 1 is in the wheelie preceding state, the wheelie amount calculation section 13 of the wheelie amount determiner section 12 calculates as the wheelie amount, a change amount of the angle of the vehicle body 6 in the rotational direction (in the clockwise direction P1 in the left side view) in which the front wheel 2 is away from the road surface, from that time point (hereinafter this time point will be referred to as a “preceding state determination time point”) when the wheelie preceding state determiner section 11 has determined that the vehicle 1 has been in the wheelie preceding state. The wheelie amount determiner section 12 sets the wheelie amount at the preceding state determination time point as a predetermined reference value. The calculated wheelie amount is a value which is a sum of the reference value of the wheelie amount and the change amount of the angle of the vehicle body 6. The reference value is, for example, zero. In that case, the change amount itself of the angle of the vehicle body 6 becomes the wheelie amount.

Any method may be used as the deriving method of the change amount of the angle of the vehicle body 6 from the preceding state determination time point and any configuration may be used as the configuration for deriving the change amount. For example, the wheelie determining device 10 may include a pitch rate sensor 34 which detects a pitch angular velocity. The pitch rate sensor 34 is a rate gyro sensor, and is mounted at a location that is in the vicinity of the center of gravity of the vehicle 1. The wheelie amount calculation section 13 receives as inputs detection values from the pitch rate sensor 34 at specified sampling rates, and integrates the input detection values. The wheelie amount calculation section 13 begins this integration at the preceding state determination time point, using the above-described reference value (e.g., zero) as an initial value.

An inertia sensor other than the rate gyro sensor may be used to derive the change amount of the angle of the vehicle body 6. Instead of the pitch rate sensor 34, the wheelie determining device 10 may include a sensor (integration gyro sensor) which detects a pitch angle, or a sensor (angular acceleration meter) which detects a pitch angular acceleration rate. The angular accelerator meter can derive the change amount of the angle of the vehicle body 6 by performing second-order time integration of the detection values input at the specified sampling rates, using the above-described reference value (e.g., zero) as the initial value. The integration gyro sensor can derive the change amount of the angle of the vehicle body 6 at a time point when the detection value is obtained, by taking a difference between the detection value input at the specified sampling rate and an initial value which is the detection value at the preceding state determination time point.

The wheelie determining device 10 may include a sensor which detects a stroke of a rear suspension, and decide as the wheelie amount a change amount of the detection value of this sensor from the preceding state determination time point. When the front wheel 2 lifts off the ground surface, the stroke is reduced. For this reason, the change amount of the stroke may be used as the pitch angle change amount of the vehicle body 6.

In the present embodiment, in the wheelie determining device 10, the change amount of the angle of the vehicle body 6 from the time point when the wheelie preceding state determiner section 11 has determined that the vehicle 1 has been in the wheelie preceding state, is calculated as the wheelie amount which is the lift-off amount of the front wheel 2 from the ground surface. Therefore, the influences of the tilt of the vehicle body which occurred before the wheelie preceding state determiner section 11 has determined that the vehicle 1 has been in the wheelie preceding state can be excluded, and thereby the lift-off amount indicating to what extent the front wheel 2 is away from the ground surface can be accurately estimated.

This will be described in detail. The wheelie amount is calculated based on the pitch angle of the vehicle body 6 in a determination process at a second stage of processing for the determination of the wheelie. Prior to the calculation of the wheelie amount, a determination process at a first stage is performed to determine whether or not the vehicle 1 has shifted from the non-wheelie-preceding state to the wheelie preceding state. This determination is performed in a state in which the wheel 2, 3 is grounded on the ground surface for a time period (namely, most of a time period during traveling) during which the vehicle 1 is traveling and the wheelie is not occurring, because of the characteristic of the determination.

If the determination process at the first stage is omitted, then the pitch angle of the vehicle body 6 continues to be measured, and the wheelie determining device 10 determines whether or not the vehicle 1 is in the wheelie state based on the measurement value, while the vehicle 1 is traveling in a state in which the wheel 2, 3 is grounded on the ground surface. In a case where the pitch angle is measured by integrating the detection values of the pitch rate sensor, a history of the pitch angular velocity is accumulated on the measurement value during the traveling. In contrast, the pitch angle of the vehicle body 6 changes due to factors which are other than the lift-off of the wheel 2, 3 from the ground surface, such as a slope of the ground surface. For this reason, the measurement value of the pitch angle includes a history of the pitch angular velocity of the vehicle body which is generated due to the factors other than the wheelie, and may not sometimes accurately reflect an actual pitch angle. Even when the measurement value of the pitch angle accurately reflects the actual pitch angle, the measurement value becomes a value as if the wheelie occurred, in a situation in which the vehicle begins to travel on an upward slope and the front wheel 2 is not away from the ground surface.

If the determination process at the second stage is omitted, the wheelie determining device 10 determines whether or not the vehicle 1 is in the wheelie state, primarily or only based on the rotational speed of the wheel 2, 3. The rotational speed of the wheel 2, 3 has a relation with an event that the vehicle 1 is in the wheelie state. However, it is difficult to derive a wheelie amount with which the extent of the wheelie can be quantitatively evaluated, based on the numeric value of the rotational speed of the wheel 2, 3. Also, the wheelie determining device 10 determines whether or not the vehicle 1 is in the wheelie state, while the wheel 2, 3 is grounded on the ground surface. However, it is difficult to precisely distinguish between a situation where the wheelie is occurring and a particular traveling situation (e.g., the rear wheel 3 is significantly slipping), only based on the behavior of the wheel 2, 3. For these reasons, the determination of the wheelie using the rotational speed of the wheel 2, 3 as the parameter has a limitation in accuracy.

In contrast, the tilt of the vehicle body 6 does not easily become the disturbance of the rotational speed of the wheel 2, 3. The numeric value of the rotational speed of the wheel 2, 3 is less disturbed even when the vehicle body is tilted due to a factor which is other than the lift-off of the wheel 2, 3 from the ground surface. In addition, the change amount of the pitch angle of the vehicle body 6 can be accurately calculated without being affected by the friction coefficient of the ground surface for a short time period.

In view of the above, in the present embodiment, the determination process at the first stage is performed based on the rotational speed of the wheel 2, 3. As described above, the determination of the wheelie using the rotational speed of the wheel 2, 3 as the parameter has a limitation in accuracy. However, after the determination process at the first stage, the determination process at the second stage using the pitch angle is performed. For this reason, the accuracy of the determination process at the first stage may be permitted to be low to some extent, in the sense that the determination process at the first stage leads to the beginning of the determination process at the second stage. The determination process at the first stage is performed without referring to the pitch angle. Thereby, a possibility of misdetermination in the determination process at the first stage is low.

In the determination process at the second stage, the change amount of the angle of the vehicle body 6 from a time point when the determination process at the first stage has been performed (the preceding state determination time point) is calculated. From the calculated value of the angle of the vehicle body 6, the influences of the tilt of the vehicle body due to the factors other than the wheelie, such as a change in the slope of the ground surface on which the vehicle 1 traveled before the preceding state determination time point, is excluded. For example, if the wheelie preceding state determiner section 11 has determined that the vehicle 1 has become the wheelie preceding state while the vehicle 1 is traveling on the upward slope, this slope of the ground surface is absorbed into the reference value. For this reason, the change amount of the angle of the vehicle body 6 from the time point when the determination process at the first stage has ended can be accurately calculated. The change amount of the angle of the vehicle body 6 simply and quantitatively indicates the lift-off amount indicating to what extent the front wheel 2 is away from the ground surface. Therefore, the extent of the wheelie can be accurately evaluated based on the calculated wheelie amount.

If the determination process at the second stage is started even though the vehicle 1 is traveling without occurrence of the wheelie, the wheelie amount remains at a value which is close to zero. Based on this wheelie amount, the wheelie determining device 10 can determine that the vehicle 1 is traveling without occurrence of the wheelie. Thereby, the wheelie determining device 10 can terminate the determination process at the second stage and perform the determination process at the first stage again.

As should be understood from the above, in accordance with the present embodiment, the wheelie amount can be accurately calculated, and the lift-off of the front wheel 2 from the ground surface can be accurately determined, compared to a case where the wheelie state is determined based on the pitch angle of the vehicle body 6 as the parameter, all the time during the traveling, or a case where the wheelie state is determined without using the pitch angle of the vehicle body 6.

<Termination Determiner Section>

The wheelie termination determiner section 14 of the wheelie amount determiner section 12 determines whether or not the wheelie state of the vehicle 1 has terminated, after the time point when the wheelie preceding state determiner section 11 determined that the vehicle 1 was in the wheelie preceding state. When the wheelie termination determiner section 14 determines that the wheelie state has terminated, the wheelie preceding state determiner section 11 starts to determine whether or not the vehicle 1 is in the wheelie preceding state. In contrast, the wheelie amount calculation section 13 ceases to calculate the wheelie amount.

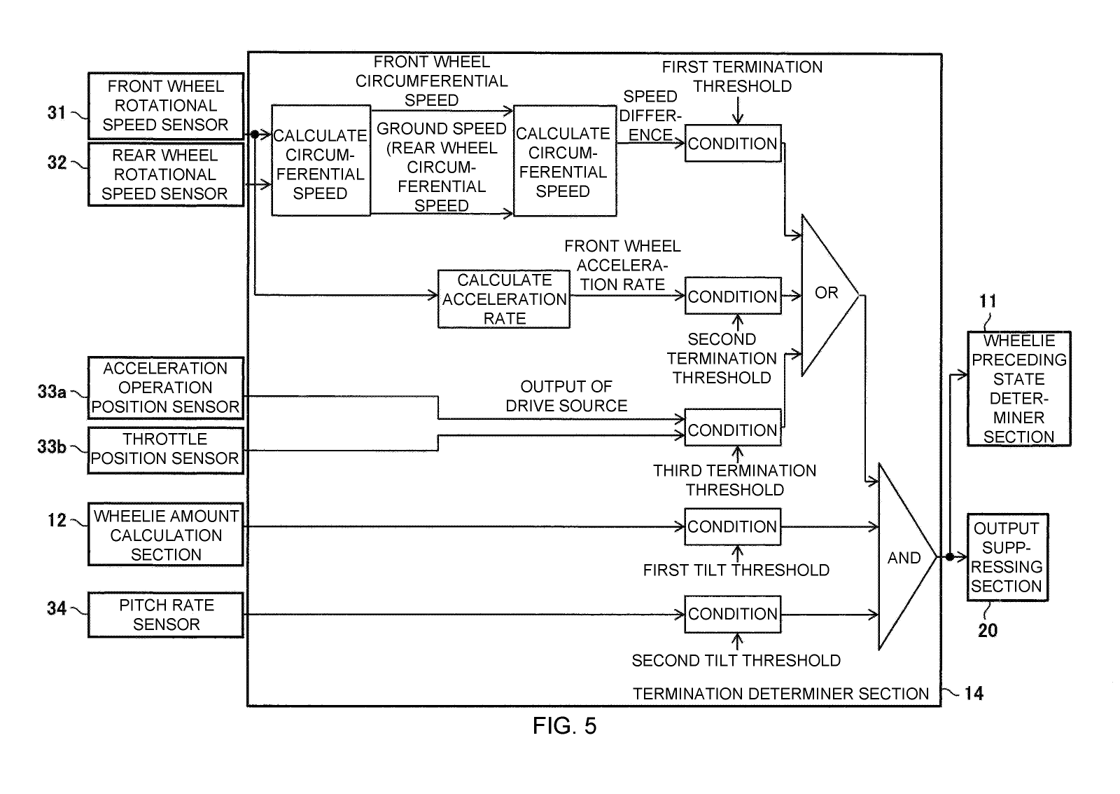

As shown in FIG. 5, the wheelie termination determiner section 14 determines whether or not the wheelie state has terminated, based on the parameters such as (1) the difference between the ground speed and the circumferential speed of the front wheel 2, (2) the rotational acceleration rate of the front wheel 2, and (3) the output of the drive source 4. These parameters (1) to (3) are also used to determine whether or not the vehicle 1 is in the wheelie preceding state (see FIGS. 4 and 5).

The wheelie termination determiner section 14 determines whether or not a “speed/output condition” relating to the speed of the vehicle 1 or the wheel 2, 3, and the output of the drive source 4 is met, and determines whether or not a “tilt condition” relating to the tilt of the vehicle body 6 is met. When both of the speed/output condition and the tilt condition are met, the wheelie termination determiner section 14 determines that the wheelie state has terminated.

Regarding the speed/output condition, the wheelie termination determiner section 14 determines whether or not a first condition is met, in which the difference between the ground speed and the circumferential speed of the front wheel 2 is less than a first termination threshold. In addition, the wheelie termination determiner section 14 determines whether or not a second condition is met, in which the rotational acceleration rate of the front wheel 2 is equal to or higher than a second termination threshold. Further, the wheelie termination determiner section 14 determines whether or not a third condition is met, in which the output of the drive source 4 is less than a third termination threshold. Differently from the determination performed by the wheelie preceding state determiner section 11, the speed/output condition is met when the wheelie termination determiner section 14 determines that one of the first to third conditions is met (see an OR circuit of FIG. 5). The first termination threshold may be equal to or different from the first start threshold. The same applies to a relation between the second termination threshold and the second start threshold, and a relation between the third termination threshold and the third start threshold.

Regarding the tilt condition, the wheelie termination determiner section 14 determines whether or not a first tilt condition is met, in which the wheelie amount calculated by the wheelie amount calculation section 12 is less than a first tilt threshold. In addition, the wheelie termination determiner section 14 determines whether or not a second tilt condition is met, in which the pitch angular velocity of the vehicle body 6 which is detected by the pitch rate sensor 34 is less than a second tilt threshold. When both of the first tilt condition and the second tilt condition are met, the tilt condition is met.

Since the wheelie termination determiner section 14 determines whether or not the wheelie state has terminated, based on the tilt of the vehicle body 6 as well as the output and the speed, it can accurately determine whether or not the wheelie state has terminated, compared to a case where it determines whether or not the wheelie state has terminated, only based on the speed and the output. Regarding the tilt of the vehicle body 6, the wheelie amount calculated by the wheelie amount calculation section 12 is used. As described above, the wheelie amount simply and quantitatively indicates the lift-off amount indicating to what extent the front wheel 2 is away from the ground surface and is accurately calculated. Therefore, the wheelie termination determiner section 14 can accurately determine whether or not the wheelie state has terminated.

(Determination of Whether or Not to Perform Wheelie Suppressing Control, Output Suppressing Section)

As described above, the wheelie determining device 10 is capable of accurately calculating the wheelie amount quantitatively indicating the extent of the wheelie. The calculated wheelie amount may be output to a controller. Further, the calculated wheelie amount may be stored in an event data recorder (not shown) mounted in the vehicle.

The wheelie amount may be used to determine whether or not to perform a wheelie suppressing control for suppressing the output of the drive source 4 and to decide the amount of the output which is to be suppressed, while the wheelie suppressing control is performed. In this case, as shown in FIG. 3, the control system of the vehicle 1 includes an output suppressing section 20 which determines whether or not to perform the wheelie suppressing control and controls the output adjustment unit 8 while the wheelie suppressing control is performed, to thereby suppress the output of the drive source 4. The output suppressing section 20 is realized by the ECU 7.

As shown in FIG. 2, when the wheelie termination determiner section 14 determines that the lift-off (wheelie) has not terminated (is occurring), the output suppressing section 20 determines whether or not the calculated lift-off amount (wheelie amount) exceeds a suppressing control threshold (S21). When the output suppressing section 20 determines that the calculated lift-off amount (wheelie amount) is equal to or less than the suppressing control threshold, it determines that a present situation is not a situation in which the output of the drive source 4 should be automatically suppressed to suppress the wheelie, and does not perform the wheelie suppressing control (if the output suppressing section 20 is performing the wheelie suppressing control, then it terminates the wheelie suppressing control (S23)), and the wheelie determining device 10 repeats the lift-off amount determination step S12 (the processing performed by the wheelie amount determiner section 12). When the output suppressing section 20 determines that the calculated lift-off amount (wheelie amount) exceeds the suppressing control threshold, it initiates the wheelie suppressing control (if the output suppressing section 20 is performing the wheelie suppressing control, then it continues the wheelie suppressing control) (S22), and the wheelie determining device 10 repeats the lift-off amount determination step S12. When the wheelie termination determiner section 14 determines that the wheelie has terminated while the wheelie suppressing control is performed, the output suppressing section 20 terminates the wheelie suppressing control (S24). In the wheel lift-off amount determination method, the process returns to the lift-off preceding state determination step S11 (processing performed by the wheelie preceding state determiner section 11) after the end of the wheelie suppressing control, and the lift-off amount determination step S12 is terminated.

In a case where the drive source 4 is the spark ignition type engine, the output suppressing section 20 reduces a throttle valve opening degree, a fuel injection amount, the number of cylinders into which fuel is to be injected, and/or the number of cylinders in which ignition plugs are actuated, and/or retards an ignition timing, in order to increase the amount of the output of the drive source 4 which is to be suppressed.

In the wheelie suppressing control, the output adjustment unit 8 is controlled in such a manner that the amount of the output of the drive source 4 which is to be suppressed is increased with an increase in the wheelie amount. A timer 22 may measure time that passes from a time point when the wheelie preceding state determiner section 11 has determined that the vehicle 1 has been in the wheelie preceding state. The output adjustment unit 8 may be controlled in such a manner that the amount of the output of the drive source 4 which is to be suppressed is increased with an increase the measured time. This makes it possible to quickly terminate the wheelie even when the extent of wheelie is large. If the wheelie continues for a long time, a difference between the circumferential speed (ground speed) of the rear wheel 3 and the circumferential speed of the front wheel 2 increases. In this case, the circumferential speed of the front wheel 2 rapidly increases to eliminate the difference when the front wheel 2 is grounded on the ground surface, which makes the rider's driving feeling worse. By changing the amount of the output of the drive source 4 which is to be suppressed, over time, it becomes possible to most effectively suppress the continuation of the wheelie for a long time. As a result, the rider's driving feeling is not worsened.

In a traveling situation which is other than occurrence of the wheelie, in which the output of the drive source 4 should be automatically suppressed, the output suppressing section 20 suppresses the output of the drive source 4. For example, the ECU 7 includes a slip determiner section 23 which determines whether or not a slip is occurring in the rear wheel 3 which is the drive wheel. When the slip determiner section 23 determines that a slip is occurring in the rear wheel 3, the output suppressing section 20 performs a slip suppressing control for suppressing the output of the drive source 4.

As described above, in a case where only the behavior of the wheel 2, 3 is referred to, it is difficult to precisely distinguish between the wheelie preceding state and a slip of the rear wheel 3 which is the drive wheel. For this reason, the wheelie preceding state determiner section 11 may determine that the first condition is met, and the slip determiner section 23 may determine that a slip is occurring in the drive wheel 3. In this case, before or after the wheelie preceding state determiner section 11 determines that all of the first to fourth conditions are met, the output suppressing section 20 performs the slip suppressing control and begins to suppress the output of the drive source 4, before the output suppressing section 20 determines that the wheelie amount reaches the suppressing control threshold. This makes it possible to reduce a possibility of occurrence of the wheelie.

In a case where a condition for performing the wheelie suppressing control (e.g., the wheelie state has not terminated, and the wheelie amount is equal to or greater than the suppressing control threshold) is met while the slip suppressing control is performed, the output suppressing section 20 terminates the slip suppressing control and performs the wheelie suppressing control. Specifically, as described above, the output suppressing section 20 decides the amount of the output of the drive source 4 which is to be suppressed, based on the wheelie amount or the time that passes from when the wheelie preceding state determiner section 11 has determined that the vehicle 1 has been in the wheelie preceding state. In this way, the control intended to primarily terminate the wheelie is performed, and the wheelie can be suitably terminated. In addition, in the slip suppressing control, the control intended to primarily suppress the slip can be performed, and the slip can be suitably terminated.

### Modified Examples

So far, the embodiments of the present invention have been described. The above-described configurations may be suitably changed.

Regarding the parameter (4) used to determine whether or not the vehicle 1 is in the wheelie preceding state, the “output of the drive source 4” may be a change in the output as well as the output (or other parameters which strongly affect the output)”. In this case, the wheelie preceding state determiner section 11 receives as input(s) detection value(s) from the sensor 33a and/or the sensor 33b at the specified sampling rates, and derives a change rate (change amount per unit time) of a present value and a past value (e.g., latest value of previous values) of the input detection value(s). This change rate may be used as the change in the output of the drive source 4. The same applies to the parameter (3) which constitutes the speed/output condition used to determine whether or not the wheelie has terminated.

The speed/output condition used to determine whether or not the wheelie has terminated may include a fourth condition in which the ground acceleration rate is equal to or higher than a fourth termination threshold in addition to the above-described first to third conditions. In this case, when any one of the first to fourth conditions is met, the speed/output condition may be met. Further, any one of the first to third conditions may be omitted from the speed/output condition. The speed/output condition includes a plurality of conditions. The speed/output condition may be met when the plurality of conditions are met at the same time, instead of when any one of the plurality conditions is met as described in the above-described embodiments.

The wheelie preceding state may be determined based on a brake force applied to the wheel 2, 3. In this case, the wheelie preceding state determiner section 11 determines whether or not a fifth condition is met, in which the brake force is less than a fifth start threshold. When all of the first to fifth conditions are met, the wheelie preceding state determiner section 11 determines that the vehicle 1 is in the wheelie preceding state. Even if the wheel 2, 3 exhibits a behavior similar to that in the case of occurrence of the wheelie, due to the brake force applied to the wheel 2, 3, the wheelie preceding state determiner section 11 can accurately determine that such a situation is not the wheelie preceding state.

Although the wheelie determining device which performs the wheel lift-off amount determination method for, in particular, the front wheel, has been exemplarily described, a device which determines whether or not the rear wheel is in a jackknife preceding state, calculates a jackknife amount, and determines whether or not a jackknife state has terminated, may be realized as in the case of the wheelie determining device.

Although the motorcycle is a suitable example of the vehicle, the present invention is applicable to vehicles other than the motorcycle.

Numerous improvements and alternative embodiment of the invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention.

1. A wheelie determining device comprising:
a wheelie preceding state determiner section which makes a comparison between a vehicle body speed with respect to a ground surface and a circumferential speed of a front wheel to determine whether or not a vehicle is in a wheelie preceding state; and
a wheelie amount determiner section which calculates as a wheelie amount which is a lift-off amount of the front wheel with respect to the ground surface, an angular change amount of the vehicle body in a rotational direction in which the front wheel is away from the ground surface, from a time point when the wheelie preceding state determiner section has determined that the vehicle has been in the wheelie preceding state.

2. The wheelie determining device according to claim 1,
wherein the wheelie preceding state determiner section estimates the vehicle body speed with respect to the ground surface based on a circumferential speed of a rear wheel.

3. The wheelie determining device according to claim 1, wherein the wheelie preceding state determiner section determines whether or not the vehicle is in the wheelie preceding state based on a vehicle body acceleration rate with respect to the ground surface.

4. The wheelie determining device according to claim 1,
wherein a rear wheel is driven by driving power generated by a drive source, and
wherein the wheelie preceding state determiner section determines whether or not the vehicle is in the wheelie preceding state based on an output of the drive source.

5. The wheelie determining device according to claim 1,
wherein the wheelie preceding state determiner section compares a difference between the vehicle body speed with respect to the ground surface and the circumferential speed of the front wheel to a threshold set for each vehicle body speed, to determine whether or not the vehicle is in the wheelie preceding state.

6. The wheelie determining device according to claim 1,
wherein the wheelie preceding state determiner section determines whether or not the vehicle is in the wheelie preceding state based on a rotational acceleration rate of the front wheel.

7. The wheelie determining device according to claim 1,
wherein the wheelie amount determiner section determines whether or not the vehicle has become a wheelie state, based on the wheelie amount, and
wherein the wheelie amount determiner section determines whether or not the wheelie state has terminated, based on a rotational speed of the front wheel and the wheelie amount.

8. A vehicle comprising:
the wheelie determining device according to claim 1;
a drive source which generates driving power for the vehicle to travel; and
an output suppressing section which performs a wheelie suppressing control for suppressing an output generated by the drive source, when the wheelie amount becomes a predetermined value or more.

9. The vehicle according to claim 8,
wherein the output suppressing section performs a slip suppressing control for suppressing the driving power generated by the drive source to suppress a slip of the front wheel with respect to the ground surface, based on the vehicle body speed with respect to the ground surface and the circumferential speed of the front wheel, and
wherein the output suppressing section terminates the slip suppressing control and performs the wheelie suppressing control, when a condition used to perform the wheelie suppressing control is met, while the slip suppressing control is performed.

10. A method of determining a lift-off amount of a wheel, which determines a lift-off amount of one of a front wheel and a rear wheel which are included in a vehicle, with respect to a ground surface, the method comprising:
making a comparison between a vehicle body speed with respect to the ground surface and a circumferential speed of one of the front and rear wheels to determine whether or not one of the front and rear wheels is in a lift-off preceding state; and
calculating as a wheel lift-off amount which is the lift-off amount of one of the front and rear wheels with respect to the ground surface, an angular change amount of the vehicle body in a rotational direction in which one of the front and rear wheels is away from the ground surface, from a time point when it has been determined that the vehicle has been in the lift-off preceding state.
